(19) United States
(12) Patent Application Publication
(10) Pub. No.: US 2026/0222302 A1
(43) Pub. Date: Jul. 30, 2026

(54) MATRIX-BASED DETECTION OF COMPLEX SECURITY GRAPH PROPERTIES USING A SECURITY GRAPH ENGINE

(71) Applicant: Microsoft Technology Licensing, LLC., Redmond, WA (US)

(72) Inventors: Andrey KARPOVSKY, Kiryat Motzkin (IL); Tamer SALMAN, Haifa (IL); Fady COPTY, Haifa (IL)

(21) Appl. No.: 18/961,029

(22) Filed: Nov. 26, 2024

(51) Int. Cl. H04L 41/142; H04L 9/40

(52) U.S. Cl. CPC H04L 41/142; H04L 63/1416; H04L 63/1433

(57) ABSTRACT

Methods, systems, and computer storage media for providing security graph analysis using a security graph analysis engine of a security management system are described. Security graph analysis is the evaluation of a computing environment’s security graph by generating an adjacency matrix that represents connections between assets, users, and permissions as nodes and edges. The security graph analysis engine leverages the adjacency matrix of a security graph to uncover various security insights by performing advanced matrix operations. The security graph analysis engine efficiently processes large and complex graphs, particularly those that are sparse and organized into blocks, by utilizing optimized algorithms and advanced computational techniques and processor (e.g., GPU) acceleration. The security graph analysis engine calculates metrics like connectivity scores to assess the overall security posture of the organization. By providing real-time analysis and actionable insights, the security graph analysis engine helps organizations quickly identify vulnerabilities and improve their security measures.

### BACKGROUND

Users rely on computing environments with applications and services to accomplish computing tasks. Distributed computing systems host and support different types of applications and services in managed computing environments. In particular, computing environments can implement a security management system that provides security posture management functionality and supports threat protection in the computing environments. For example, cloud security posture management (CSPM) and enterprise security posture management can include the following: identifying and remediating risk by automating visibility, executing uninterrupted monitoring and threat detection, and providing remediation workflows to search for misconfigurations across diverse cloud computing environments and infrastructure.

### SUMMARY

Various aspects of the technology described herein are generally directed to systems, methods, and computer storage media for, among other things, providing security graph analysis using a security graph analysis engine of a security management system. Security management generally refers to planning, implementing, controlling, and monitoring security measures to protect assets, resources, and information from various threats and risks in computing environment. Security graph analysis is the evaluation of a computing environment’s security graph by generating an adjacency matrix that represents connections between assets, users, and permissions as nodes and edges. This process supports connectivity scoring, path discovery, and clustering, which yield security insights and recommendations to enhance the environment’s security posture.

The security graph analysis engine processes and analyzes data from a computing environment to assess security posture and identify potential vulnerabilities. The security graph analysis engine interprets information about the computing environment from a security graph and an adjacency matrix to construct and analyze a comprehensive view of the environment’s security. The security graph analysis engine uses techniques like graph analysis, and anomaly detection to evaluate risks and generate security insights. Through automated workflows, it continuously monitors for threats and provides alerts when suspicious activities or deviations from expected patterns are detected. The security insights generated by the security analysis engine help inform security decisions, perform remediation efforts, and enhance the overall resilience of the system.

Conventionally, security management systems are not configured with a comprehensive computing logic and infrastructure to efficiently and adequately manage and analyze the increasingly complex relationships among various security components. For example, use of security graphs introduces a layer of complexity due to the intricate relationships among various security components. This complexity can lead to prolonged processing times, as analyzing large graphs with numerous nodes and edges demands significant computational resources. As a result, the outputs generated from these analyses can often be noisy, filled with irrelevant or misleading information. This situation complicates the security learning process considerably. Security professionals may find it time-consuming to sift through vast amounts of data to extract meaningful insights. Moreover, the challenge of distinguishing between critical threats and less significant alerts can hinder the effectiveness of security measures. Consequently, organizations may struggle to maintain a security posture, as the potential for overlooking genuine threats increases amid the noise.

A technical solution – to the limitations of conventional security management systems – can include providing security graph analysis resources via a security graph analysis engine that supports using an adjacency matrix of a security graph to discover longer paths and analyze the overall structure efficiently in a security management system. Security graph analysis engine resources can include operations for generating the adjacency matrix comprising matrix entries that represent connections between nodes. The adjacency graph supports analyzing the security graph structure and discovering paths between nodes. Moreover, the security graph analysis engine can support discovering a number of paths of a particular length between node pairs (i.e., matrix exponentiation); utilizing techniques optimized for sparse matrices to improve computation efficiency (i.e., sparse matrix optimization); and applying block matrix multiplication to efficiently analyze the security graph’s structure, particularly for security graphs organized into blocks. Additionally, the security graph analysis engine supports calculating connectivity metrics, such as the connectivity score, to assess the graph’s overall structure and adherence to security policies. As such, the security management system can be improved based on security graph analysis engine resources that operate to provide efficient discovery of paths in a security graph to gain security insights.

In operation, in a first embodiment, a graph is accessed. The graph represents relationships between entities of a computing environment and stores information about the computing environment. A matrix is generated from the graph. Each entry of the matrix indicating a connection, or lack of connection, between two nodes of the graph. A connectivity score is generated by analyzing the matrix. The connectivity score is a metric used to evaluate connectivity within the graph. An insight related to security of the computing environment is generated using the connectivity score. The insight is communicated to a security management client.

In a second embodiment, a security incident associated with a computing environment is identified. A graph representing security information about the computing environment is accessed. A matrix is generated from the graph. A connectivity score is generated by analyzing the matrix. The connectivity score is a metric used to evaluate connectivity within the graph. An anomaly in the computing environment is detected using real-time monitoring of the computing environment by way of the graph and the matrix. In response to detecting the anomaly, an alert is generated.

In a third embodiment, a request for security information about a computing environment is communicated. Based on communicating the request, a visualization comprising one or more insights based on a graph and a matrix is received. Each entry of the matrix indicates a connection, or lack of connection, between two nodes of the graph. Display of the visualization is caused on a security management client.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The technology described herein is described in detail below with reference to the attached drawing figures, wherein:

FIGS. 1A and 1B are block diagrams of an exemplary security management system including a security graph analysis engine, in accordance with aspects of the technology described herein;

FIGS. 2A and 2B are flow diagrams associated with an exemplary security management system including a security graph analysis engine, in accordance with aspects of the technology described herein;

FIG. 3 provides a first exemplary method of providing security graph analysis using a security graph analysis engine, in accordance with aspects of the technology described herein;

FIG. 4 provides a second exemplary method of providing security graph analysis using a security graph analysis engine, in accordance with aspects of the technology described herein;

FIG. 5 provides a third exemplary method of providing security graph analysis using a security graph analysis engine, in accordance with aspects of the technology described herein;

FIG. 6 provides a block diagram of an exemplary security management system suitable for use in implementing aspects of the technology described herein;

FIG. 7 provides a block diagram of an exemplary distributed computing environment suitable for use in implementing aspects of the technology described herein; and

FIG. 8 is a block diagram of an exemplary computing environment suitable for use in implementing aspects of the technology described herein.

### DETAILED DESCRIPTION

### OVERVIEW

A security management system supports management of security aspects of resources and workloads in computing environments. The security management system can help enable protection against threats, help reduce risk across different types of computing environments, and help strengthen a security posture of computing environments – i.e., security status and remediation action recommendations for computing resources including networks and devices. For example, the security management system can provide real-time security alerts, centralize insights for different resources, and provide for preventative protection, post-breach detection, and automated investigation, and response.

A security graph is a representation, which may be visual, which models the relationships between various security entities, such as users, devices, applications, and systems, within an organization's network (e.g., computing environment). It is used to identify potential vulnerabilities, access control points, and dependencies, helping to assess and manage security risks by understanding how different components interact and where threats may emerge. In particular, the security graph can support gaining insights that can help improve the organization’s security posture.

A security graph is recognized as an effective security feature that enhances customer security. A security graph can be visual representation of the relationships and dependencies among security components in a cloud computing environment. In a security graph, nodes represent elements such as virtual machines, databases, and users, while edges indicate interactions or trust relationships. Security policies and controls may also be illustrated, showing how they protect various components. For example, in a cloud storage service, a security graph might show a node for the storage system, connected to nodes for user accounts and access controls.

Conventionally, security management systems are not configured with a comprehensive computing logic and infrastructure to efficiently and adequately manage and analyze the increasingly complex relationships among various security components. By way of illustration, there are different types of insights that can be derived from a security graph. Local and simple insights are straightforward observations, such as identifying all potential attack paths from weak entry points to valuable targets within the organization. On the other hand, advanced insights are more complex and pertain to larger sections of the graph or the entire graph. For example, one can measure how well the organization adheres to the ‘least privilege’ principle, which ensures that individuals have only the minimum levels of access necessary to perform their job functions.

The least privilege principle is a security concept that dictates that individuals, applications, and systems should be granted only the minimum levels of access—or permissions—necessary to perform their functions. This principle aims to reduce the risk of unauthorized access, data breaches, and other security incidents by limiting exposure to sensitive resources. For example, if an employee needs access to a specific database for their job, they should only be given permission to that database and not to other sensitive areas of the system. By adhering to the least privilege principle, organizations can better protect their data and reduce potential attack surfaces, thereby enhancing overall security.

To assess this, metrics like the global clustering coefficient, which measures the degree to which nodes in a graph tend to cluster together, or modularity, which indicates the strength of division of a network into modules, can be calculated. A connectivity score is a metric used to evaluate the extent of connectivity within the security graph. For example, the connectivity score may range from 0 to 1, where a score of 1 indicates a fully connected graph, meaning every entry point can access every target, and a score of 0 signifies a fully disconnected graph, which is essentially useless for practical purposes. However, analyzing security graphs, especially large or complex ones, can be quite challenging. These challenges include long processing times due to the complexity and size of the graph, and unclear and noisy outputs that can be difficult to interpret and may contain irrelevant information. These issues are particularly problematic during ongoing attacks, where quick and accurate analysis is crucial to expose and mitigate the effects of the attack.

To effectively manage security, especially during active incidents, efficient analysis of the security graph is necessary. This analysis should quickly identify problematic areas and reflect improvements in near real-time, ensuring that the organization can respond promptly and effectively to security threats. By leveraging the insights provided by security graphs and addressing the challenges in their analysis, organizations can significantly enhance their security measures and overall posture. As such, a more comprehensive security management system – with an alternative basis for performing secure management operations – can improve computing operations and interfaces in security management systems

### DESCRIPTION OF TECHNICAL SOLUTION

At a high level, a security graph analysis engine is provided to analyze and interpret security graphs. The security graph analysis engine leverages an adjacency matrix of a security graph to uncover various security insights by performing advanced matrix operations. The security graph analysis engine efficiently processes large and complex graphs, particularly those that are sparse and organized into blocks, by utilizing optimized algorithms and computational techniques associated with GPU acceleration. The security graph analysis engine calculates key metrics like connectivity scores to assess the overall security posture of the organization. By providing real-time analysis and actionable insights, the security graph analysis engine helps organizations quickly identify vulnerabilities and improve their security measures.

The following terms provide a framework to understand the technical solution behind a security analysis engine.

Security graph refers to a structured representation of a computing environment’s assets, users, and permissions. Each node represents an asset (e.g., servers, databases) or user, and each edge represents an access relationship or permission, allowing for visualization and analysis of connectivity and access patterns.

Adjacency matrix refers to a matrix format that represents the security graph, with each entry indicating a connection (or lack of) between two nodes. This matrix enables simplified calculations and analysis, supporting security insight generation related to the security posture of the environment.

Connectivity score refers to a quantitative metric derived from the adjacency matrix, reflecting the level of connectivity within the security graph. The connectivity score measures how tightly nodes are connected, helping assess compliance with security principles such as “least privilege” and “cluster isolation.”

A security insight refers to an actionable observation or finding generated by analyzing the security graph and its connectivity score, aimed at improving the security posture. Examples of insights include identifying high-risk nodes with excessive connections or pinpointing vulnerabilities due to over-access.

Security posture refers to the overall security standing or defense level of the computing environment, as assessed through various metrics like connectivity scores and security insights. It represents how well the system can prevent, detect, and respond to potential security incidents.

Security incident refers to specific event or breach that affects the integrity, confidentiality, or availability of the computing environment, potentially indicating unauthorized access or other threats. Identifying such incidents is essential for timely alerts and remediation.

Anomaly refers to irregular or unexpected behavior in the security graph, often identified through real-time monitoring and analysis of the connectivity score. Anomalies may signify unusual access patterns or unauthorized activity, prompting further investigation.

Real-time refers to the immediate or near-instantaneous processing and response to events as they occur, with minimal delay. In this context, real-time monitoring ensures that data is analyzed, decisions are made, or actions are taken within a time frame that supports ongoing operations or dynamic scenarios effectively. Real-time monitoring includes the continuous observation and analysis of a security graph to detect changes in access relationships or connectivity patterns as they occur. Real-time monitoring leverages the adjacency matrix to dynamically update metrics, such as connectivity scores, and promptly identify anomalies, such as unauthorized access or unusual activity, triggering alerts for immediate response.

Alert refers to a notification triggered by detecting an anomaly or security incident, signaling the need for immediate action. Alerts are communicated to stakeholders or systems to enable timely responses and mitigate potential risks.

Security posture visualization refers to a graphical or visual representation of the security posture, including metrics, connectivity scores, and insights derived from the security graph and adjacency matrix. This visualization helps stakeholders understand the environment’s current security state and highlights areas needing attention.

By way of illustration, in a security graph, the adjacency matrix serves as a comprehensive representation, where each entry indicates whether a direct edge (or a weighted connection) exists between two nodes. A direct edge is an edge from one node to another node without any intervening nodes. This adjacency matrix provides a complete snapshot of the security graph’s structure, capturing features like paths, connected components, cliques, and other interrelationships, and laying the foundation for discovering security insights.

Matrix analysis techniques offer an effective approach to extracting insights from such graph representations. Advances in computational methods, including GPU acceleration and AI-driven algorithmic optimizations, have made matrix computations on even large-scale matrices more efficient. For instance, raising the adjacency matrix to the power of k reveals the number of paths of length k between any two nodes, illuminating potential access routes across the graph. While this operation is generally resource-intensive, optimizations tailored to specific cases, such as sparse or block matrices, enable efficient handling.

Security graphs, in particular, are highly suitable for these optimizations due to their unique structural properties. These security graphs are typically sparse, as most assets are not directly connected due to distinct roles or lack of shared business logic. Additionally, security graphs often show a block structure, with specific edges (such as SSH key access to storage) representing critical paths, while others (like software installed on a VM) are less so. Such sparse, block-organized matrices enable rapid path discovery, making optimized matrix analysis a powerful tool for generating insights.

Using tailored matrix operations for the security domain allows the security analysis engine to derive insights into the entire security graph’s connectivity, a metric of security posture, before resorting to more complex analytics. Ideally, a security graph reflects a “small-world” structure, where assets form tightly connected, well-defined clusters, linked by sparse connections across clusters. Block matrix multiplication can capture this structure efficiently, offering a high-level overview of the connectivity that is directly related to the organization’s security policies.

By way of illustration, matrix operations are used to efficiently assess the connectivity across a network. One such operation is block matrix multiplication, which can break the problem into smaller, more manageable blocks, allowing the system to process large networks quickly. This method helps to identify not only direct relationships but also indirect ones—connections that might not be immediately obvious. For instance, even if a workstation is not directly connected to a server, it may still be able to communicate with it through intermediate assets like a router or firewall. Matrix operations can reveal these indirect links, providing a more comprehensive understanding of the network’s structure.

Once the matrix operations are complete, the security analysis engine can look for patterns in the network’s connectivity. An ideal small-world structure emerges, where assets are grouped into tightly connected clusters but only sparsely connected to assets in other clusters. These sparse connections between clusters are important because they represent potential points of vulnerability in the system. The analysis of these clusters using block matrix multiplication offers insights into the overall security posture of the network. If the clusters are well connected internally, with security measures in place between them, the computing environment is considered more secure. However, if the connections between clusters are weak or non-existent, it could indicate a security gap—a potential vulnerability where the network could be exposed to threats.

By using tailored matrix operations in this way, security analysts can gain a clear and detailed understanding of how well the different components of the network are connected, how well they align with the organization’s security policies, and where improvements might be needed. In addition, tailored matrix operations help analyze the connectivity structure of a network by efficiently capturing the relationships between assets or components. The resulting data from these operations can be used to calculate a connectivity score, which quantifies the overall strength and quality of the network's connectivity, indicating the strength or vulnerabilities of the system’s security posture.

The connectivity score derived from the adjacency matrix functions as a practical KPI for security, measuring the organization’s adherence to security policies (e.g., least privilege principle). This metric is designed to be any of the following: transparent, interactive, commutative, or transitive. In particular the connectivity score can be associated with insights that highlight areas of both strong and weak connectivity; allowing users to assess connectivity at varying organizational levels, such as teams or projects; and the connectivity scores are granular and cumulative. For example, improving connectivity at the level of individual entities (e.g., limiting access to sensitive nodes) will enhance the scores at higher organizational levels.

By way of example, an interconnected network of servers, databases, and workstations can defined a computing environment. A security system defines a security graph to map which systems have access to others. In the security graph, each node represents an asset (like database, server, or workstations), and each edge represents a connection or permission allowing access from one asset to another.

The organization calculates a “connectivity score” from the adjacency matrix of this graph, which captures all access relationships. This connectivity score serves as a practical KPI for security, helping measure how well the organization follows the “least privilege” principle. For example, a high score might suggest over-permissive access, while a lower score indicates restricted, minimal access, aligning well with “least privilege” goals.

This connectivity score is transparent, as it clearly shows areas with strong or weak connectivity. If the database is tightly restricted with access granted only to the one or two other systems, it will have low connectivity and reflect a strong security posture. Conversely, if many systems can access the server, that node would have high connectivity, indicating potential over-permissiveness.

The score is also interactive. Security analysts can assess connectivity at different organizational levels, such as departments or projects, to identify where access may need adjustment. For instance, they might focus on a selected team’s access levels, checking if only necessary servers and databases are accessible to them.

The connectivity score is commutative and transitive. This means that improving security at the level of specific assets or individuals will directly benefit the larger structure. If the organization reduces access for a sensitive node (e.g., limiting server access to only specific users of a department), the score for the department as a whole will improve. This improvement will also impact the organization’s overall score, providing a cumulative effect where tightening controls in one area strengthens security across larger segments of the organization. In this way, the connectivity score enables the organization to monitor and adjust security practices effectively, ensuring that access aligns closely with the least privilege principle across all levels.

This approach enables real-time analysis and immediate feedback on security improvements. By associating connectivity scores with specific entities and organizational units, this system can identify areas requiring strengthened restrictions, predict the impact of these changes on overall connectivity scores, and demonstrate how individual enhancements can bolster the organization’s overall security posture.

The security posture can be specifically associated with security insights, where a security insight is a data-driven observation derived from analyzing a security graph and its adjacency matrix, providing a deeper understanding of an organization’s security posture. Security insights highlight specific aspects of the computing environment, such as potential vulnerabilities, patterns of access, or misalignments in access permissions, often in relation to security best practices.

Security insights typically include both quantitative and qualitative indicators. For instance, metrics such as a connectivity score or a clustering coefficient can reveal the level of access or interconnectivity between assets. A high connectivity score might indicate that access is too permissive, while a clustering coefficient could show if assets in a particular region of the network are overly interconnected, potentially amplifying risks.

In addition to identifying potential risks, security insights can be targeted. They pinpoint specific nodes (assets) or edges (access relationships) that could be vulnerable. For example, if a sensitive database has multiple indirect access paths, this might highlight an area where permissions should be restricted to mitigate risk.

The purpose of these security insights is to provide actionable information that drives security improvements. By identifying areas where changes to access configurations, permissions, or network segmentation could strengthen security, security insights prompt organizations to take concrete actions. Some insights are generated in real time, responding to shifts in network activity or access patterns. For example, an insight might be triggered by a sudden spike in connectivity or an unusual access request, which could signal a potential security breach or ongoing cyberattack.

For example, in analyzing a security graph, a security insight might reveal that a particular application server (Node X) is connected to numerous user accounts. This high connectivity could pose a risk if one of those user accounts is compromised, potentially granting unauthorized access to sensitive systems. In response, the security insight could recommend reducing access privileges or implementing stricter authentication controls to mitigate the risks associated with this node.

Ultimately, security insights are valuable because they help bridge the gap between raw data and strategic security decisions. They enable organizations to continuously monitor and adjust their access controls, detect emerging threats, and ensure alignment with the principle of least privilege. By providing proactive, data-driven guidance, security insights empower security teams to address potential vulnerabilities before they can be exploited.

Advantageously, the embodiments of the present technical solution include several inventive features (e.g., operations, systems, engines, and components) associated with a security management system having a security graph analysis engine. The security graph analysis engine generating the adjacency matrix comprising matrix entries that represent connections between nodes. The adjacency graph supports analyzing the security graph structure and discovering path between nodes. The security graph analysis engine resources (e.g., operations, interfaces, and data) are a solution to a specific problem (e.g., limitations in providing comprehensive security graph analysis with consideration of the complexity in security graphs that prolong processing times when analyzing large graphs). The security graph analysis engine can support discovering a number of paths of a particular length between node pairs (i.e., matrix exponentiation); utilizing techniques optimized for sparse matrices to improve computation efficiency (i.e., sparse matrix optimization); and applying block matrix multiplication to efficiently analyze the security graph’s structure, particularly for security graphs organized into blocks. Additionally, the security graph analysis engine supports calculating connectivity metrics, such as the connectivity score, to assess the graph’s overall structure and adherence to security policies.

### EXAMPLE SYSTEMS AND RESOURCES

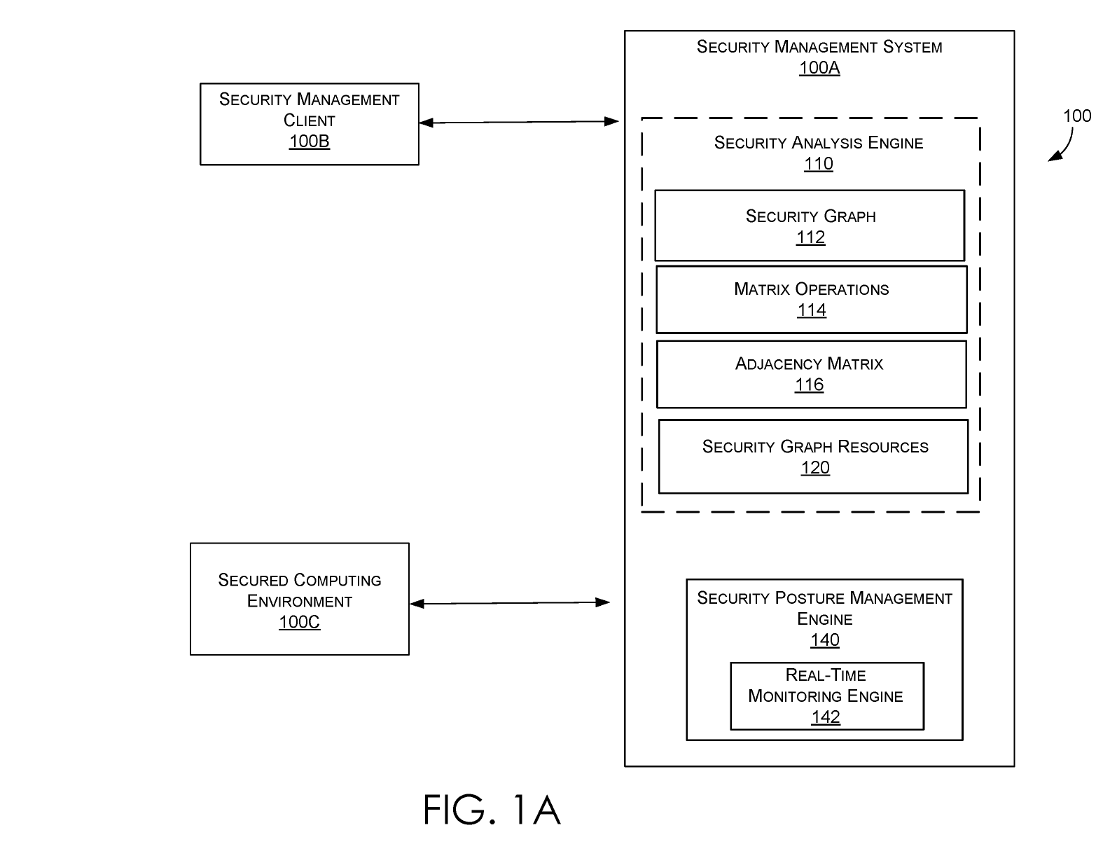

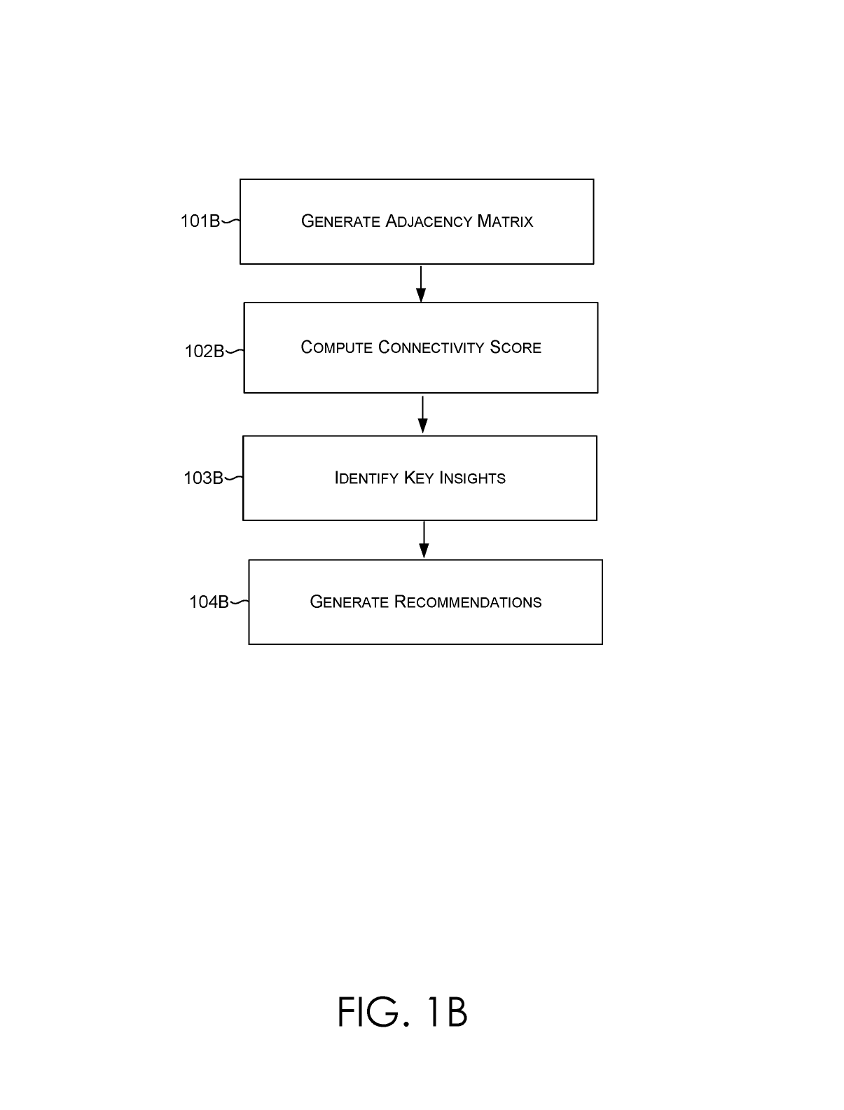

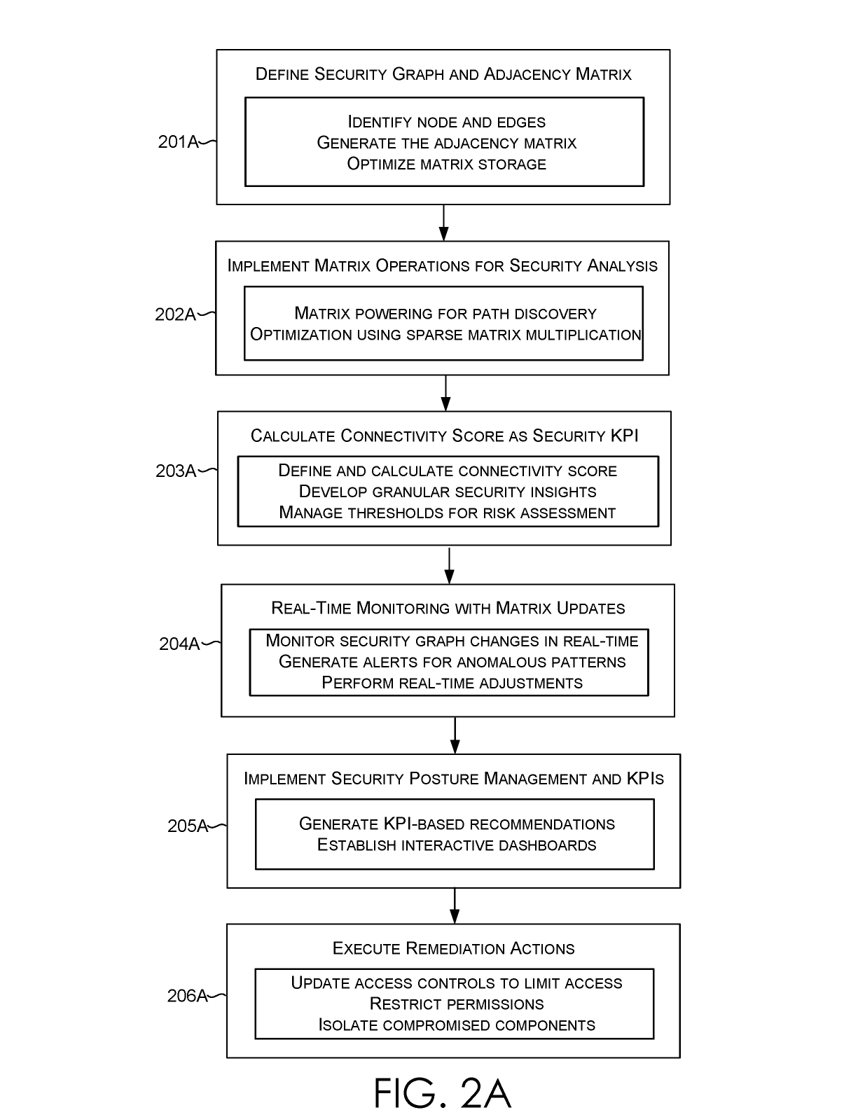

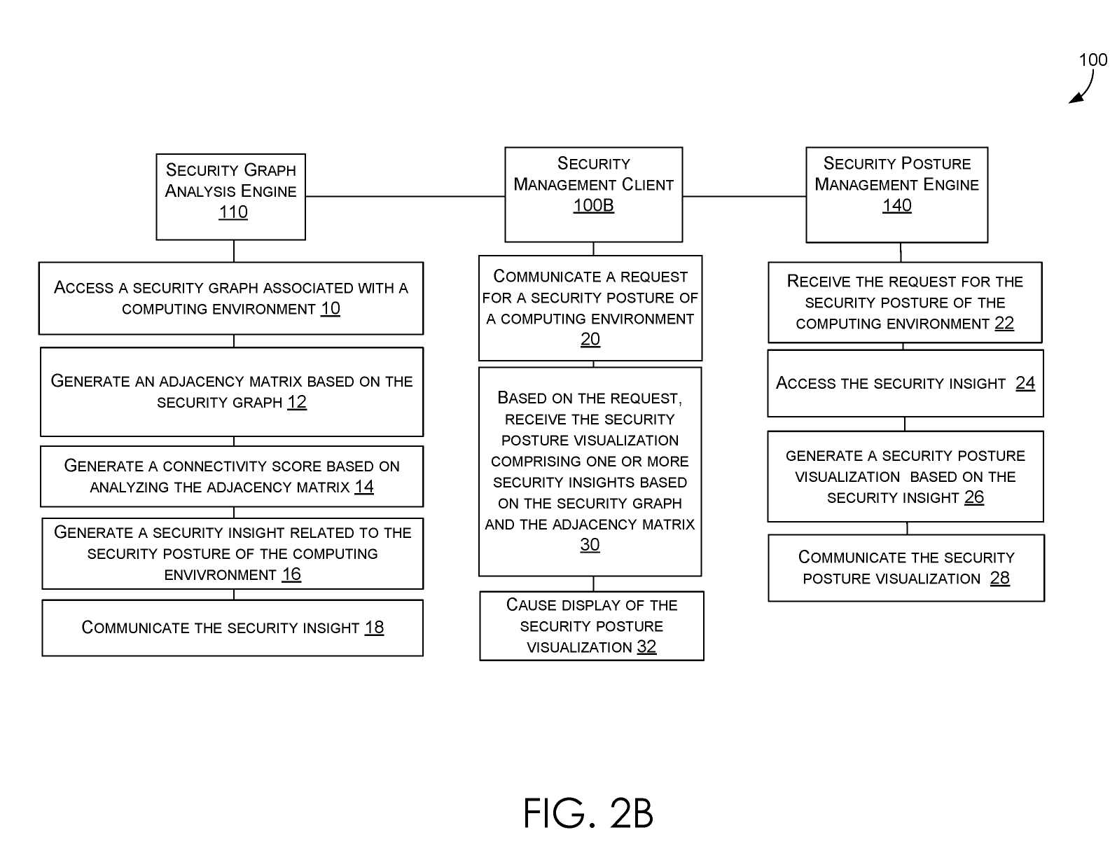

Aspects of the technical solution can be described by way of examples and with reference to FIGS. 1A, 1B, 2A and 2B. FIG. 1A illustrates a cloud computing environment (system) 100, security management system 100A, security management client 100B; secured computing environment 100C; security graph analysis engine 110, security graph 112, matrix operations 114, adjacency matrix 116, security graph resources 120; and security posture management engine 140 including real-time monitoring engine 142.

The cloud computing environment 100 provides a security management system 100A that is associated with a security management client 100B, a secured computing environment 100C, and security graph analysis engine 110 for providing security graph analysis functionality. Secured computing environment 100C – associated with a security graph (e.g., security graph 112) for security management – integrates various systems, devices, and network components that are represented as nodes and their interactions or vulnerabilities as edges. Secured computing environment 100C uses security graph analysis techniques to assess the security posture by identifying critical nodes, attack paths, or potential points of failure, enabling proactive threat detection and risk mitigation. Secured computing environment 100C supports tasks like vulnerability assessment, incident response, and policy enforcement by leveraging algorithms to model, analyze, and simulate security scenarios across the graph.

The security management system 100A including the security analysis engine 110 operates as a platform that supports continuous assessment and enhancement of an organization’s security posture through real-time analysis and dynamic policy enforcement. The security management system 100A enables monitoring, analyzing, and refining security settings across various organizational layers. The security management system 100A functions as the overarching platform orchestrating the interaction between various engines, interfaces, and data resources. It integrates data from multiple sources, like access logs, permission settings, and network configurations, and centralizes it for analysis. The security management system 100A enables seamless communication between the components and ensures efficient execution of operations, such as real-time threat detection and security posture assessment.

Security analysis engine 110 is responsible for transforming security data into meaningful insights. Using data from network infrastructure configurations, access logs and permission configurations, it constructs a visual and analytical representation of the organization’s security landscape, known as the security graph (e.g., security graph 112). By performing various matrix-based operations on this security graph 112, the security analysis engine 110 identifies connectivity patterns, evaluates permissions, and checks adherence to security principles such as the least privilege. For instance, it assesses which nodes (representing systems or users) have access to sensitive data, and whether that access is necessary.

Security graph analysis resources 120 broadly refers to an entity, such as data, an interface, or an operation, that provides the necessary inputs, mechanisms, or tools required to perform a security graph analysis. Security graph analysis resources 120 enables the execution of processes by offering access to information, services, or computational capabilities. For example, security graph analysis resources 120 support storing and maintaining the security graph data structures. Security graph analysis resources 120 can include adjacency matrices that represent relationships between nodes, such as access rights and data flows between different users or systems. Metadata provides additional context to these relationships, which allows the enables drawing nuanced conclusions about potential vulnerabilities. Data is updated regularly to reflect the latest security configurations, enabling the security analysis engine 110 to work with accurate and current information.

At the core of the analytical process is the security graph 112, a visual and mathematical representation of organizational relationships and permissions. Security graph 112 models entities as nodes, with edges representing access permissions or data transfer rights. The security graph 112 structure allows enables visually mapping and analyzing relationships, making it easier to identify clusters, bottlenecks, and other patterns critical for assessing the overall security posture.

To conduct meaningful analyses on security graph 112, matrix operations 114 are performed. Matrix operations 114 include matrix multiplication, addition, and exponentiation to reveal connectivity and access patterns across multiple layers. For example, matrix exponentiation can help identify all possible paths between nodes, which is critical for understanding how easily unauthorized access could spread through the network.

An adjacency matrix 116 is a representation of a security graph (e.g., security graph 112), where an entry indicates the presence or absence of a connection (i.e., a connection or lack of connection) between two nodes. This matrix can be used to model binary connections, where an entry is set to 1 if a connection exists and 0 if it does not, or weighted connections, where the value represents the strength or level of access between nodes. For example, consider a security graph with three nodes: a user, a server, and a database. If the user has access to the server and the server has access to the database, the binary adjacency matrix would have a value of 1 for the connections between the user and server, and between the server and database, with all other entries set to 0. In contrast, if the user’s access to the server is limited to read-only (represented as 1), and the server has full access to the database (represented as 2), the weighted adjacency matrix would reflect these values. The adjacency matrix116 serves as a simplified and calculable representation of the security graph, enabling efficient mathematical operations. GPUs, with their parallel processing capabilities, accelerate these calculations, allowing the system to handle large and complex graphs efficiently.

Adjacency matrix 116 simplifies the complex relationships and dependencies between different security entities (e.g., networks, services, or threats), making it easier to analyze and compute potential vulnerabilities, access paths, or attack surfaces. Adjacency simplifies the security graph 112 by converting its structure into a grid of 0s and 1s (or other weights), where each row and column represents a node, and the matrix elements indicate the presence or absence of direct connections between nodes. This reduces the complexity of visually mapping out relationships, allowing the security graph’s connectivity to be represented in a compact, standardized format.

Adjacency matrix 116 is calculable because it can be easily manipulated mathematically. Operations such as matrix multiplication, addition, and transposition can reveal paths, detect vulnerabilities, or compute metrics like centrality or reachability. This makes it a powerful tool for computational analysis, enabling automated algorithms to evaluate security risks, detect potential threats, or find shortest paths in the network. In this way, adjacency matrix 116 helps in efficiently assessing security risks and interactions by providing a clear, calculable structure for further analysis, such as pathfinding or connectivity checks.

Real-time monitoring engine 118 continuously tracks changes in access patterns and system configurations. By monitoring events as they occur, it can detect anomalies or sudden changes in connectivity. For example, if a user suddenly gains access to new resources or sensitive systems, the real-time monitoring engine 118 flags this change as a potential security issue. Alerts generated by this component are communicated to security personnel and are also fed into the security posture management engine 140 for further processing.

Security posture management engine 140 aggregates insights generated by the system to assess the organization’s security health. By examining connectivity scores, access paths, and vulnerability points, it generates a connectivity score that reflects how closely the organization adheres to its security policies. If the score indicates over-connectivity or high-risk areas, the security posture management engine 140 suggests corrective actions, such as removing unnecessary access rights or isolating certain systems. It also provides a report that security teams can use to understand and improve the organization’s security posture.

Users interact with the security management system 100A through security management client 100B, a user interface that displays insights, alerts, and recommendations generated by the system. Through the security management client 100A security analysts can view real-time data, monitor connectivity scores, and explore the current security graph. Additionally, they can make adjustments to permissions, access policies, and other configurations based on the system’s recommendations.

By way of illustration, the security graph 112 is a structured model representing the assets and access relationships within secured computing environment 100C. Nodes in this graph can represent assets (such as servers, databases, applications, and user accounts), while edges can represent access permissions (such as read, write, execute, SSH, or API calls) that define how these assets are interrelated. By accessing this graph, the system analysis engine 110 is equipped with a real-time map of the security posture of the computing environment. For example, in an enterprise network, nodes may represent user accounts, databases, and web applications, and edges may indicate permissions, such as API access between the user accounts and web applications or database read/write access granted to specific applications.

An adjacency matrix 116 is generated based on the security graph 112, offering a simplified, calculable representation of the computing environment’s access relationships. This matrix has entries that represent direct or weighted edges (access connections) between two nodes, with binary entries for simple access (0 = no access, 1 = access) or weighted entries (e.g., 1 = read, 2 = write) for varied access levels. The adjacency matrix 116 supports executing matrix operations, such as matrix exponentiation, block matrix multiplication, and sparse matrix optimization, which streamline the analysis of access patterns. For example, suppose there are four nodes: User1, App1, DB1, and Server1. If User1 has API access to App1, and App1 has read/write access to DB1, the matrix entries between User1 to App1 and App1 to DB1 are marked accordingly, forming the initial adjacency matrix for computational analysis.

With the adjacency matrix 116 in place, matrix operations facilitate a deeper analysis of access relationships and potential security risks within the secured computing environment 100C. Matrix operations include the following:

Matrix Exponentiation: This operation raises the adjacency matrix to the power k to discover all paths of length k between nodes. For example, raising the matrix to the power of 3 identifies all three-step access paths, helping reveal indirect paths that could pose security risks if, for instance, sensitive data is accessible indirectly through several nodes.

Block Matrix Multiplication: When assets are organized in functional clusters (e.g., servers grouped with specific applications), block matrix multiplication calculates the internal and external connectivity of these clusters. By analyzing internal connectivity, the solution can assess if assets within a cluster are excessively interconnected, indicating a potential privilege escalation risk. Block matrix multiplication might reveal high internal connectivity in a web server cluster, suggesting unnecessary connections that need reviewing for compliance with the least privilege principle.

Sparse Matrix Optimization: In large environments, sparse matrix optimization ensures that only significant connections are analyzed, optimizing performance and reducing computational load. For example, a matrix of a large network with 100 nodes, exponentiating the adjacency matrix 116 reveals multiple paths, identifying any indirect access to a high-security node, such as a customer data repository.

The connectivity score is a numerical metric calculated from the adjacency matrix, representing the “connectedness” of the graph. A high connectivity score implies numerous paths and relationships, indicating a higher degree of interconnectivity, which may pose security risks if not strictly managed. Conversely, a low score suggests fewer access relationships and a likely closer adherence to the least privilege principle. The connectivity score may be normalized to provide a value between 0 and 1, aiding in evaluating the security posture at a glance. For example, a score of 0.7 in an organization with a highly sensitive data environment might signal a need for access restrictions, while a score of 0.3 could be considered within an acceptable range for a tightly controlled environment.

Using the connectivity score, the security analysis engine 110 generates security insights relevant to the organization’s access control practices. These insights may highlight areas where access is more permissive than necessary or where certain assets act as high-connectivity hubs, suggesting a review of their access settings to mitigate risks. For example, if a high score is detected and specific nodes (e.g., a database containing customer information) are shown to have multiple access paths, the system might recommend reconfiguring access permissions for these nodes to limit exposure.

The security insights are communicated through a visualization of the security posture, providing stakeholders with a clear view of high-risk areas, high-connectivity clusters, and recommendations for improving security. This visualization can be provided to decision-makers, as it helps illustrate the potential risks and necessary actions concisely. For example, a security posture visualization might display a graph highlighting high-connectivity nodes in red and clusters with excessive access paths in orange, alongside textual recommendations for reviewing permissions on specific nodes.

Real-time monitoring of the computing environment detects security incidents and anomalies by continuously evaluating changes in the adjacency matrix. If unexpected connections arise—such as new access paths to sensitive nodes or an abnormal increase in connectivity score—an alert is generated to warn of a potential cyberattack or unauthorized access escalation. An alert is a notification generated by the security management system when a potential security anomaly or threat is detected within the computing environment. It is triggered by specific conditions, such as unusual connectivity patterns, sudden increases in access permissions, or deviations from established connectivity scores. These alerts are communicated to security analysts through the security management client, providing detailed information about the nature and location of the potential threat. This enables timely investigation and remediation actions to address and mitigate the identified security risks effectively. For example, during an ongoing cyberattack, real-time monitoring detects a sudden increase in connectivity to the financial records database, triggering an alert. Security teams can then review and address the anomaly to mitigate potential risks.

The security analysis engine also support employing Key Performance Indicators (KPIs), where a KPI is a measurable metric used to evaluate the security posture of the computing environment. A KPI reflects specific aspects of the system’s performance, such as connectivity, risk levels, or adherence to security principles like “least privilege.” A first KPI is the connectivity score, which quantifies the overall interconnectivity within the security graph. Higher scores indicate a denser network of access paths, suggesting potential over-permissioning. For example, a connectivity score of 0.8 on a scale of 0 to 1 might highlight the need to limit unnecessary connections between users and sensitive assets. Another important KPI is the clustering coefficient, which measures the extent to which nodes within a cluster are interconnected. High coefficients in sensitive areas could signify excessive internal connectivity, increasing vulnerability. For instance, a clustering coefficient of 0.9 for a database cluster may indicate that nodes are overly interconnected, violating the principle of least privilege. The modularity score is a KPI that assesses the degree to which the graph can be divided into distinct clusters or communities. This score reflects network segmentation, with higher modularity scores indicating better isolation between groups. A modularity score of 0.7 might demonstrate effective segmentation, ensuring minimal access between unrelated teams or systems.

The average path length measures the typical number of steps required to traverse the graph between nodes. Shorter paths in sensitive areas can indicate that critical assets are too easily accessible. For example, an average path length of 1.5 for sensitive databases might suggest a need for stricter access controls to enforce multi-layered security. Lastly, the high-risk node count identifies the number of nodes flagged for having an excessive number of access connections, making them potential vulnerabilities. A high-risk node count of 10 might reveal servers or accounts with over-permissive access configurations that require immediate review. These KPIs collectively provide actionable insights to monitor, analyze, and enhance the security of a computing environment.

Based on the connectivity score, security insights, and KPIs, actionable recommendations are generated. If a connectivity score exceeds a set threshold, suggestions might include tightening access controls on specific nodes, improving cluster isolation, or limiting cross-cluster connections to uphold the least privilege principle. For example, the KPI threshold is set at 0.5 and the score is 0.7, recommendations might include restricting access to the database clusters and re-evaluating permissions for application servers that show high connectivity with user accounts.

Once recommendations are reviewed, stakeholders can execute remediation actions directly. Security management system 100A communicates the indication to execute these actions, such as access restrictions or network reconfigurations, triggering automated or manual changes to improve the environment’s security posture. For example a recommendation to restrict API access for a high-connectivity application can be reviewed and then executed automatically, adjusting the system configuration to limit access.

With reference to FIG. 1B, FIG. 1B illustrates a flow diagram associated with an example implementation of the technical solution. By way of example, consider a simplified security graph for an organization where each node represents an asset such as a server, application, database, or user, while each edge represents an access relationship, such as user access, SSH keys, or API calls. The objective is to evaluate adherence to the "least privilege" principle by aiming for limited access, minimizing unnecessary connections between assets.

At Step 101B – Generate the Adjacency Matrix: The adjacency matrix is generated to represent the security graph. For example, with 20 nodes representing various assets (databases, servers, apps, and users), edges are assigned to denote access relationships and permissions (e.g., read, write, execute). The adjacency matrix A is initialized with zeros for all 20 nodes, representing no connections initially. Then, specific connections are added based on the organization’s setup. Each matrix entry A[i][j] is assigned a value of 1 if there is a direct edge from i to j ; otherwise, it remains 0. Weighted values may be assigned for different access levels, with higher values indicating stronger connections.

At Step 102B – Compute Connectivity Score: After constructing the adjacency matrix, the connectivity score is calculated to assess the “connectedness” of the graph. This can be done by raising the matrix to various powers (e.g., up to length 3) to reveal multi-hop paths and then normalizing by the maximum possible connections, resulting in a connectivity score between 0 and 1. Matrix exponentiation identifies paths of increasing lengths, which are then summed and divided by the maximum possible paths to yield the final score. During this analysis, cluster isolation insights are generated by examining whether nodes within a cluster are more densely connected to each other than to nodes in other clusters, indicating how well-isolated or contained each cluster is. If clusters (e.g., groups of applications associated with specific databases) are present within the graph, block connectivity is calculated by dividing the adjacency matrix into smaller sections. Each block represents a cluster (e.g., Users, Servers, Applications, Databases) with internal connections within each cluster and sparse connections between clusters. This organization facilitates the calculation of internal connectivity for each block, providing insight into cluster isolation and the security implications of inter-cluster connections.

At Step 103B – Identify Key Insights: With the connectivity score determined, specific insights and potential problem areas are identified by analyzing nodes with high connectivity, which may signal excessive access and violate the least privilege principle. Nodes that serve as high-access points (e.g., frequently accessed databases) are noted to assess whether additional restrictions are needed. A function is then used to identify nodes with high connection counts, indicating potential areas for access reduction.

At Step 105B – Generate Recommendations: Actionable recommendations are generated based on the overall connectivity score and individual cluster scores. For high-risk nodes, access restrictions are suggested to reduce connectivity. Cluster isolation may also be improved by minimizing cross-cluster connections, particularly where clusters display high internal connectivity. These targeted recommendations are designed to enhance the organization’s security posture by aligning access practices more closely with the least privilege principle, thus reducing unnecessary connectivity and fortifying asset protection.

With reference to FIG. 2A, FIG. 2A illustrates a flow diagram associated with providing security graph analysis using a security analysis engine in a security management system. A security graph analysis workflow can include the following steps:

At step 201A – Access Security Graph and Generate Adjacency Matrix: The security graph, which consists of nodes (assets) and edges (connections between assets), is the starting point. The adjacency matrix is then generated to represent this graph mathematically. Each entry in the matrix corresponds to the presence and weight of an edge between two nodes in the graph. In particular, assets, users, or security entity within the organization can be represented as a node. Connections between nodes are established as edges, which signify direct permissions, relationships, or dependencies. Each entry in the adjacency matrix is populated to denote either the presence or absence of a direct connection between nodes, with weights applied in cases where levels of access differ. This approach allows critical or stronger links to be emphasized with higher values. To optimize memory usage and computational efficiency, sparse matrix storage techniques, such as Compressed Sparse Row or Compressed Sparse Column formats, can be utilized due to the inherently sparse nature of security graphs. Block matrices are then constructed for larger graphs, where tightly connected clusters are represented as smaller blocks and only sparse connections are established between these blocks, mimicking typical inter-cluster relationships in a security context.

At step 202A – Implement Matrix Operations for Security Analysis: Efficient matrix operations are employed to analyze the security graph. For example, the adjacency matrix is raised to a power k to reveal all k-step paths between nodes. In this way, each non-zero entry in the resulting matrix indicates the existence of a multi-hop path, effectively identifying indirect connections. Given the computational intensity of matrix exponentiation, GPU acceleration, particularly through libraries such as CUDA (i.e., Compute Unified Device Architecture) is leveraged to improve performance. The block structure of the security graph is utilized, where blocks represent small-world clusters, characterized by dense intra-block connections and sparse inter-block links. This structure allows operations within blocks to be performed with higher speed, while calculations between sparse, unrelated blocks are minimized. Through these small-world indicators, security posture is assessed by examining block-level density and connectivity between blocks. A matrix that deviates from this structure may signify inefficient access management that could require adjustments. Sparse matrix multiplication further optimizes this process by focusing only on block matrices, which simplifies operations on densely connected areas while avoiding irrelevant calculations.

At step 203A – Calculate Connectivity Score a Security KPI – connectivity scores are calculated to serve as Key Performance Indicators (KPIs) for security assessments. Connectivity scores are calculated by assessing intra-cluster density within each block and inter-cluster connections across blocks. These scores provide insight into individual nodes, teams, or projects with potentially excessive connectivity, which can indicate areas needing stricter permissions. Block-level scores are then aggregated to produce a higher-level connectivity assessment across different organizational scopes, such as individuals, teams, or departments. Thresholds are defined to categorize connectivity as “good” or “risky,” allowing analysts to identify over-connected nodes or high-risk clusters that may benefit from restricted permissions or access control adjustments.

At step 204A – Real-time Monitoring with Matrix Updates: real-time monitoring is optionally implemented for dynamic security management. A real-time monitoring engine can be set up to continuously observe any changes within the security graph, updating the adjacency matrix whenever connections are added or removed. Paths and connectivity scores are recalculated dynamically as the security graph evolves. Anomalous connectivity patterns, such as an unexpected increase in a node’s score, are flagged to indicate potential risks. Potential attack vectors are identified by monitoring these unusual connectivity patterns, particularly if low-sensitivity nodes are found to have newly established paths to high-sensitivity data. Automated recommendations for access adjustments are generated to address high-risk areas.

At step 205A – Implement Security Posture Management and KPIs: security posture is managed by leveraging connectivity scores to define KPIs that reflect security health across organizational scopes. Benchmarks for KPIs such as average cluster connectivity and intra-block versus inter-block connection ratios are established to monitor security improvements over time. Connectivity scores are used to suggest specific, actionable recommendations, such as removing redundant permissions or adjusting access within over-connected teams. The effects of these recommendations on the organization’s overall security posture are calculated, providing transparency and support for informed decision-making. To enhance usability, interactive dashboards are developed for security analysts to visualize scores, pinpoint high-risk nodes, and review actionable recommendations. By allowing analysts to drill down into various organizational levels, the dashboards facilitate granular monitoring of security metrics.

At step 206A – Execute Remediation Action: dynamic remediation actions are executed to address identified security gaps. The adjacency matrix is analyzed to pinpoint vulnerabilities, allowing immediate actions to be taken to bolster security posture. Compromised components are isolated, access controls are updated, and permissions are restricted as necessary to contain potential security breaches and dynamically reinforce security protocols across the organization.

With reference to FIG. 2B, FIG. 2B illustrates a cloud computing system 100 having security graph analysis engine 110, security management client 100B, and security posture management engine 140.

The security graph analysis engine 110, at block 10, accesses a security graph associated with a computing environment; at block 12, generates an adjacency matrix based on the security graph; at block 14, generates a connectivity score based on analyzing the adjacency matrix; at block 16, generates a security insight related to the security posture of the computing environment; and at block 18, communicates the security incident.

The security management client 100B, at block 20, communicates a request for a security posture of a computing environment. The security posture management engine 140, at block 22, receives the request for the security posture of the computing environment; at block 24, accesses the security insight; at block 26, generates a security posture visualization based on the security insight; at block 28, communicates the security posture visualization. The security management client 100B, at block 30, based on the request, receives the security posture visualization comprising the security insight based on the security graph and the adjacency matrix; and at block 32, causes display of the security posture visualization.

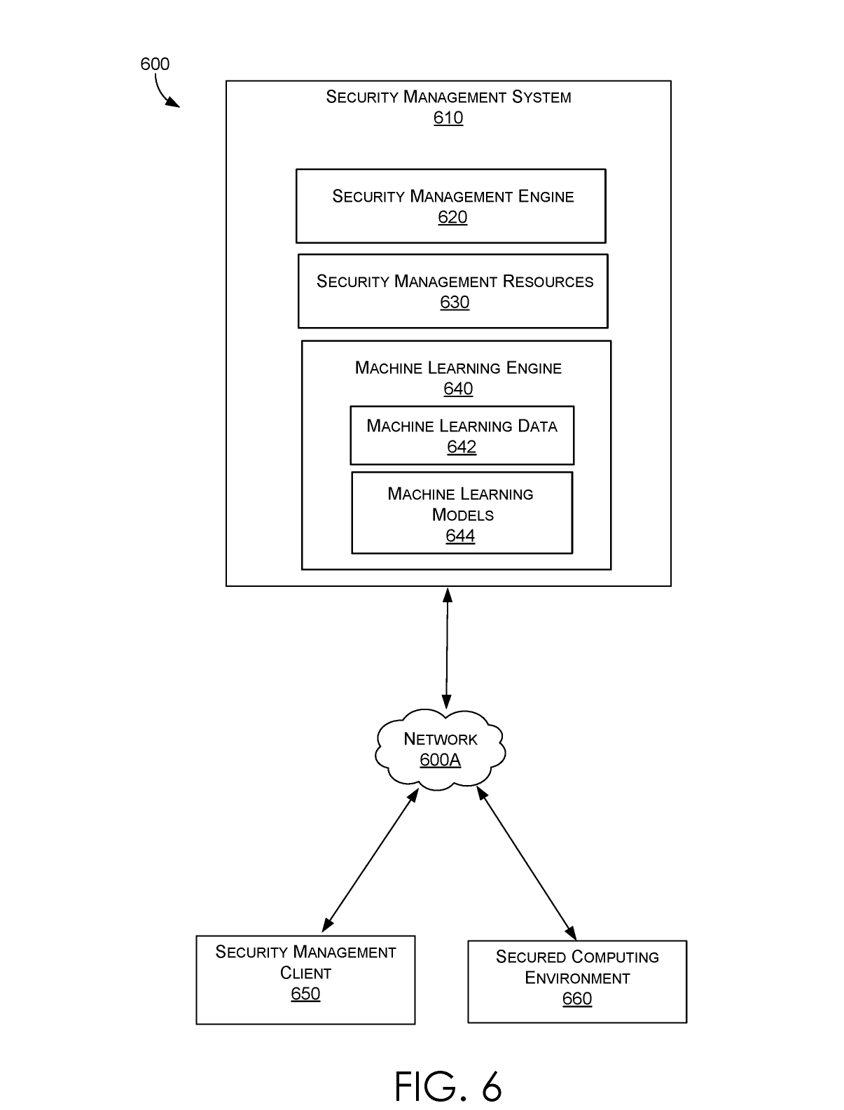

Aspects of the technical solution have been described by way of examples and with reference to FIGS. 1A, 1B, 2A and 2B. FIG. A1 is a block diagram of an exemplary technical solution environment, based on example environments described with reference to FIGS. 6, 7 and 8 for use in implementing embodiments of the technical solution are shown. Generally the technical solution environment includes a technical solution system suitable for providing the example cloud computing system 100 in which methods of the present disclosure may be employed. In particular, FIG. 1A illustrates a high level architecture of the cloud computing system 100 in accordance with implementations of the present disclosure, among other engines, managers, generators, selectors, or components not shown (collectively referred to herein as “components”).

### EXAMPLE METHODS

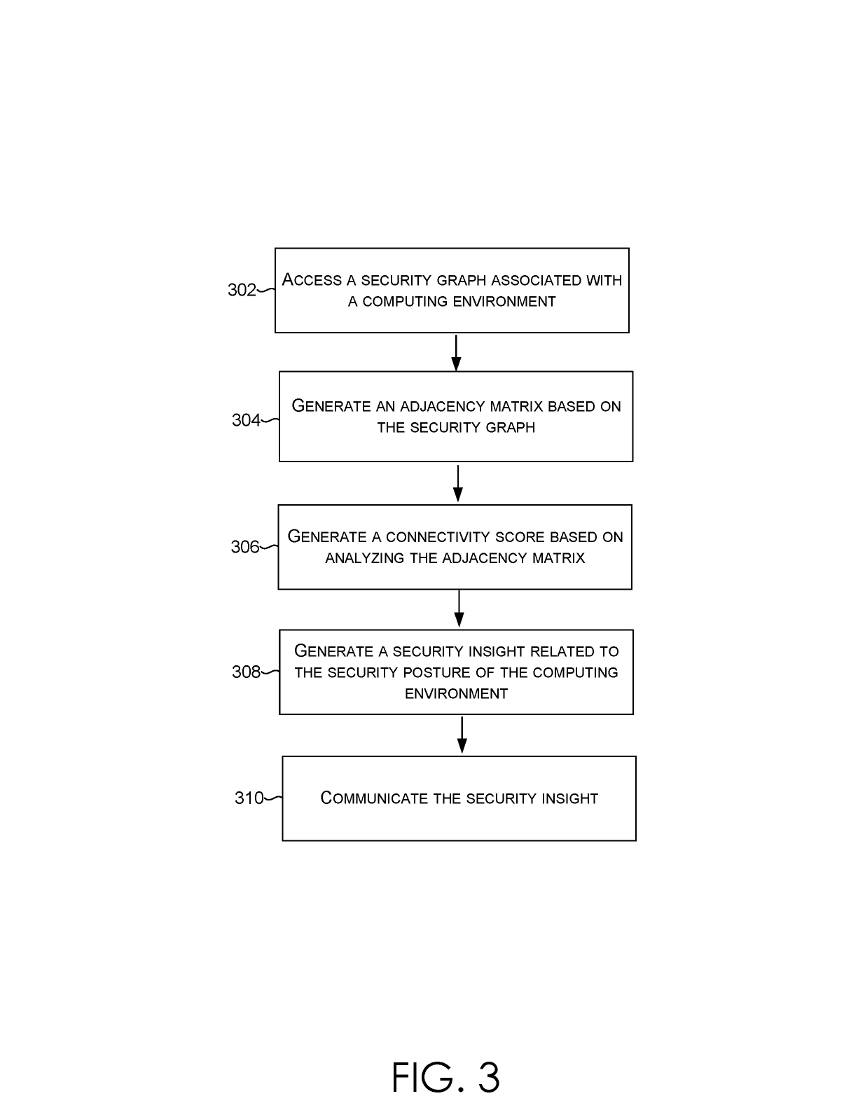

With reference to FIGS. 3, 4, and 5, flow diagrams are provided illustrating methods for providing security graph analysis using a security graph analysis engine of a security management system. The methods may be performed using the security management system described herein. In embodiments, one or more computer-storage media having computer-executable or computer-useable instructions embodied thereon that, when executed, by one or more processors can cause the one or more processors to perform the methods (e.g., computer-implemented method) in the security management system (e.g., a computerized system).

Turning to FIG. 3, a flow diagram is provided that illustrates a method 300 for providing security graph analysis using a security graph analysis engine of a security management system. At block 302, access a security graph associated with a computing environment. At block 304, generate an adjacency matrix based on the security graph. The adjacency matrix is a simplified and calculable representation of the security graph that support identifying security insights related to security posture of the computing environment. At block 306, generate a connectivity score based analyzing the adjacency matrix. The connectivity score is a metric used to evaluate connectivity within the security graph. At block 308, generate a security insight related to the security posture of the computing environment. At block 310, communicate the security insight.

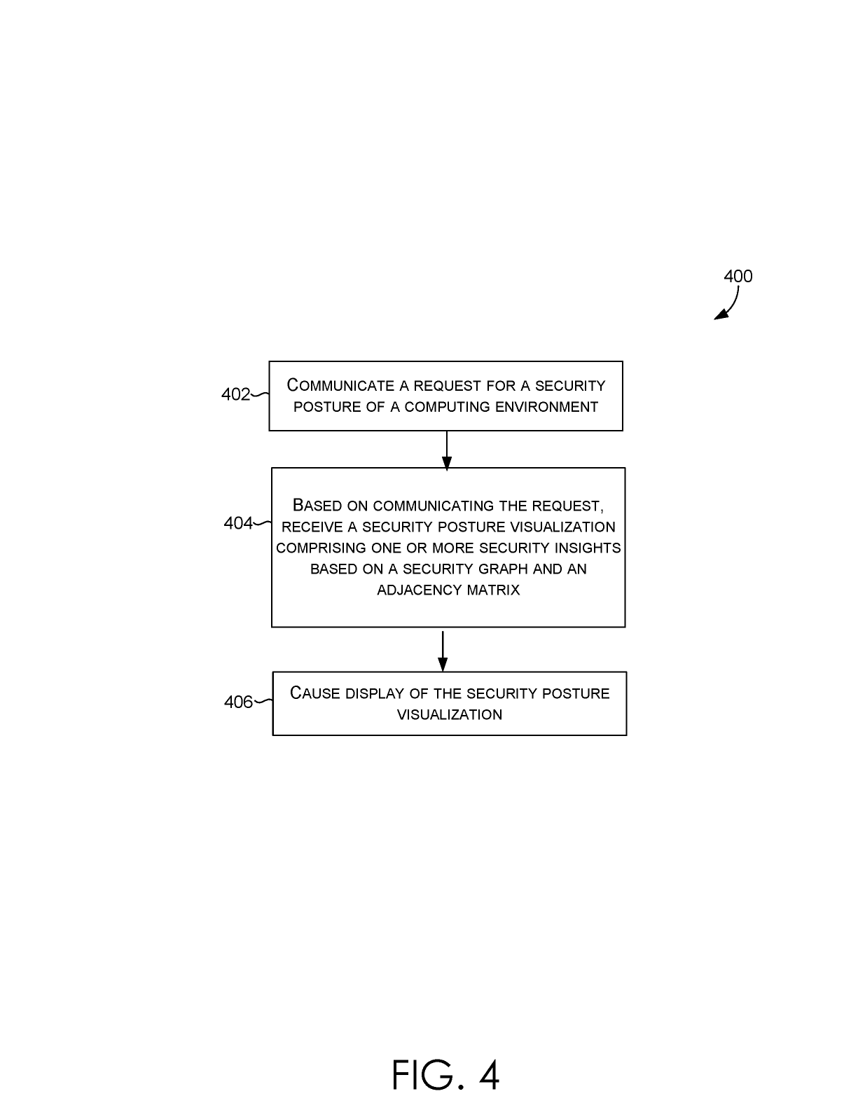

Turning to FIG. 4, a flow diagram is provided that illustrates a method 400 for providing security graph analysis using a security graph analysis engine of a security management system. At block 402, communicate a request for a security posture of a computing environment. At block 404, based on the request, receive a security posture visualization comprising one or more security insights based on a security graph and an adjacency matrix. At block 406, cause display of the security posture visualization.

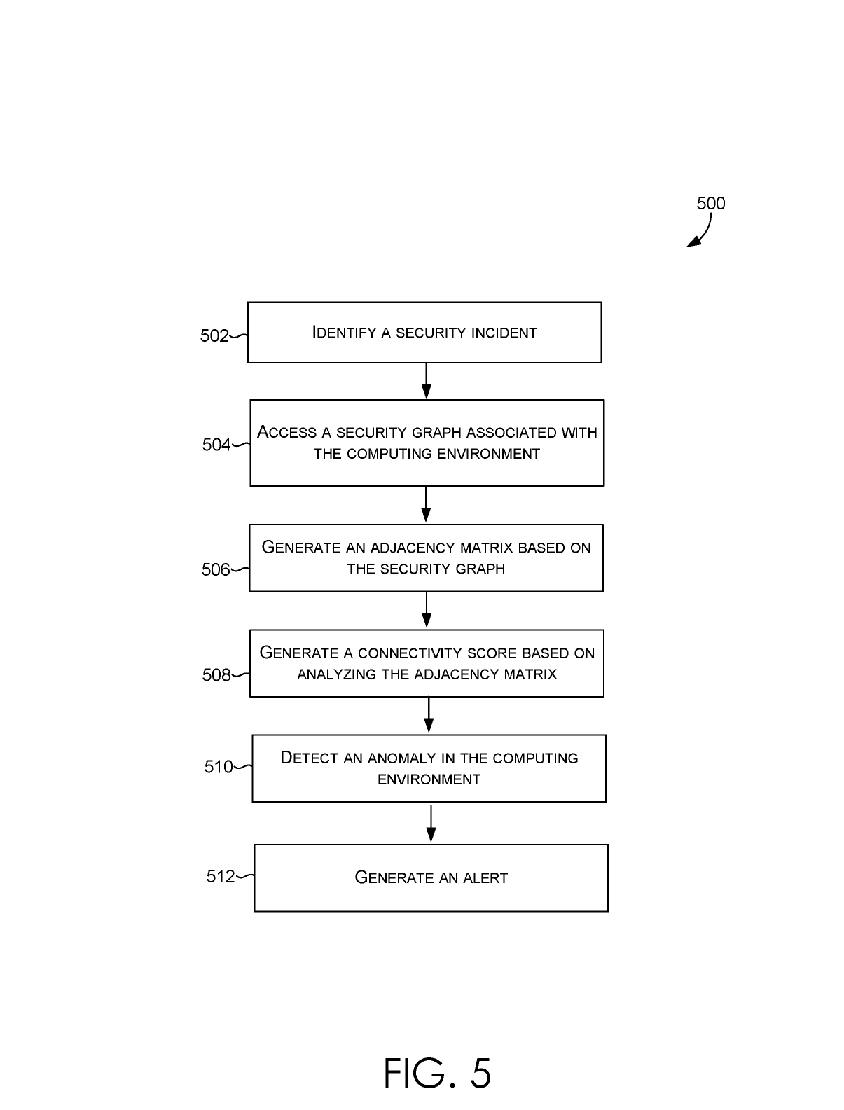

Turning to FIG. 5, a flow diagram is provided that illustrates a method 500 for providing security graph analysis using a security graph analysis engine of a security management system. At block 502, identify a security incident associated with a computing environment. At block 504, access adjacency matrix based on the security graph. The adjacency matrix is simplified and calculable representation of the security that supports identifying security insights related to a security posture of the computing environment. At block 506, generate a connectivity score based on analyzing the adjacency matrix. The connectivity score is a metric used to evaluate connectivity within the security graph. At block 508, detect an anomaly in the computing environment based on real-time monitoring of the computing environment based on the security graph and the adjacency matrix. At block 510, based on the anomaly, generate an alert. In some examples, in response to detecting an anomaly, an automated action is triggered to mitigate the anomaly, such as by closing access to a computing service, isolating a node of the computing environment, or other action.

### TECHNICAL IMPROVEMENT

Embodiments of the present techniques have been described with reference to several inventive features (e.g., operations, systems, engines, and components) associated with a security management system. Inventive features described include: operations, interfaces, data structures, and arrangements of computing resources associated with providing the functionality described herein relative with reference to a security graph analysis engine. Functionality of the embodiments of the present invention have further been described, by way of an implementation and anecdotal examples – to demonstrate that the operations for providing the security graph analysis engine as a solution to a specific problem in security management technology to improve computing operations in security management systems.

By way of example, the security graph analysis engine generating the adjacency matrix comprising matrix entries that represent connections between nodes. The adjacency graph supports analyzing the security graph structure and discovering path between nodes. The security graph analysis engine resources (e.g., operations, interfaces, and data) are a solution to a specific problem (e.g., limitations in providing comprehensive security graph analysis with consideration of the complexity in security graphs that prolong processing times when analyzing large graphs). The security graph analysis engine can support discovering a number of paths of a particular length between node pairs (i.e., matrix exponentiation); utilizing techniques optimized for sparse matrices to improve computation efficiency (i.e., sparse matrix optimization); and applying block matrix multiplication to efficiently analyze the security graph’s structure, particularly for security graphs organized into blocks. Additionally, the security graph analysis engine supports calculating connectivity metrics, such as the connectivity score, to assess the graph’s overall structure and adherence to security policies.

### ADDITIONAL SUPPORT FOR DETAILED DESCRIPTION

### EXAMPLE SECURITY MANAGEMENT SYSTEM IN A COMPUTING ENVIRONMENT

Referring now to FIG. 6, FIG. 6 illustrates a computing environment in which implementations of the present disclosure may be employed. In particular, FIG. 6 shows a high level architecture of an example cloud computing platform 600 and security management system 610 that can host a technical solution environment. It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

The cloud computing environment 100 provides computing system resources for different types of managed computing environments. For example, the cloud computing platform supports delivery of computing services – including compute, servers, storage, databases, networking, and intelligence. The components of cloud computing environment 600 may communicate with each other over a network 600A which may include, without limitation, one or more local area networks (LANs) and/or wide area networks (WANs).

The security management system 610 provides security management functionality for computing environments. The security management system 610 supports planning, implementing, controlling, and monitoring security measures to protect assets, resources, and information from various threats and risks in computing environment. Security management system 610 is configured to trigger alerts for potential or actual threats – including suspicious behavior or malicious behavior – in a computing environment. For example, an alert configuration can be defined to include alert settings, which if met, trigger an alert. The security alert can refer to a human-readable, technical notification regarding current vulnerabilities, exploits, and other security issues associated with a computing environment. The alert can be communicated to a client device that is managed by a security administrator who can then follow up on the alert.

Different types of potential threats and actual threats exist, for example, use of proxies to gain access to a computing environment or unauthorized running of crypto mining software in a computing environment. An attack on a cloud computing environment – for example, performed by a malicious actor – can include several attack operations that are executed to gain access to resources on the cloud computing environment. The attack operations can trigger alerts, when the security system is configured to monitor for these types of attack operations. If multiple attack operations are identified – and a determination that the attack operations are related is made – the alerts associated with the attack operations can be defined as a security incident. The security incident can refer to a collection of correlated alerts and corresponding security data that make up a story of an attack. The attack story can be associated with a security graph and an attack path definition that identifies attack objects (e.g., attack operations, compromised resources, file locations and file types). The attack path can describe how an attacker gained access to a computing environment and related operations and computing resources associated with the attack and unauthorized access. A security incident can advantageously combine multiple alerts associated with a single attack to support managing and responding to the security incident.

The security management system 610 includes a security management engine 620 that is a computing environment that supports executing computational tasks associated with the security management system 610. The security management engine 620 can be a hardware or software component that performs computational operations, such as, mathematical calculations, data processing, and algorithm execution. The security management system 610 integrates security management resources 630 into security management system 610 to effectively provide security management in a computing environment.

The security management engine 610 can be a security posture management engine that is responsible for communicating with security management engine client 660. The security management engine client 660 supports client-side security management operations for providing security management in the security management system 610. The security management engine client 660 supports presenting a security posture visualization associated with security management engine output and communicating an indication to perform a remediation action associated with security management engine output. The security management engine 620 operates to provide visibility to security status of resources in a computing environment. Security posture information can be associated with security management engine output. Security posture information can include security management engine output as described herein with regard to the technical solution.

The security management engine 620 includes a security graph API that provides access to a security graph security graph data. The security graph provides telemetry data associated with a plurality of resources in a computing environment. In particular, the telemetry data can be security data that is associated with security providers in a computing environment. The security graph and security graph API can support integrating security alerts from different security providers via an API connector that streams alerts to the security management engine 620.

The security management engine 620 may assess threats and develop risk scores – using risk assessment operations. A risk associated with security management engine output can used to generate security posture information. In particular, a risk score can refer to a numerical value that represents the level of risk associated with a particular security incident associated with the annotation. It takes into account various factors such as the likelihood of the event occurring and the potential impact of the event if it does occur. The risk score is used to prioritize actions and allocate resources accordingly.

The security management engine 620 can further support generating security posture visualizations based on security management engine output. The security posture information can be generated security management engine output such that security posture information is prioritized and filtered. A prioritization identifier (e.g., high, medium, low) can be provided in the security posture visualization in combination with an alert associated with a security incident. Alternatively, a notification associated with the security management information, security prioritization information or the alert can be communicated. Other variations and combinations of communications associated with security management engine output are contemplated with embodiments described herein.

The security management client 650 can support accessing a security posture visualization and causing display of the security posture visualization. The security management client 650 can include the security posture management engine client that supports receiving security posture information associated security management engine output from the security management system 610 and causing presentation of the security posture information. The security posture information can specifically include security posture visualizations associated with the security management engine output. The secure posture visualization can further include remediation actions associated different alerts – including alerts that are associated with the security management engine output. The security management system can be a security management system described in U.S. Patent Application Serial No. 18/451,405, filed August 17, 2023, entitled “ARTRIFICIAL INTELLIGENCE ENGINE IN A SECURITY MANAGEMENT SYSTEM,” which is incorporated herein by reference in its entirety.

The security management client 130 can further support executing a remediation action. In particular, the security posture visualization can include a remediation action for an alert associated with security management engine output. The security management client 130 can receive an indication to perform the remediation action associated with security management engine output. Based on receiving the indication to execute the remediation action, the security management client 130 can communicate the indication to execute the remediation action to cause execution of the remediation action.

The security management resources 630 refer to computing elements (e.g., components, capability, or entities) that collectively enable the security management engine 620 operations. The security management resources 630 encompass a spectrum of computing elements, beginning with the diverse operations the security management resources 630 can perform, ranging from complex computations to data manipulations. Interfaces, an integral part of the security management resources 630, provide the means for both user interaction and seamless integration with external systems, ensuring a dynamic and interactive computing experience. The data facet of the security management resources 630 involves various types: input data, which is the information provided for processing; processing data, representing the data manipulated during computational tasks; and output data, the results generated by the security management engine 620. In this way, the security management resources 630 support the broader security management engine 620 and security management system 610.

Security management resources 630 Security graph analysis engine resources that support leveraging contextual information and impact analysis to thwart or mitigate ongoing attacks on a computing environment. Security graph analysis engine resources encompass the core operations, interfaces, and data components within security management system 610, collectively supporting its functionality in overseeing diverse computing environments across the cloud computing system 600. Operations of the Security graph analysis engine resources include understanding the normal behavior and processes within the computing environment. This includes monitoring system operations, network traffic, user activities, and application behavior to establish a baseline of normalcy. When an attack occurs, security analysts can analyze the deviation from normal operations to identify anomalies or suspicious activities. By understanding the context in which these deviations occur, such as the timing, sequence, and frequency of events, analysts can assess the severity and potential impact of the attack. Interfaces, including graphical user interfaces, command-line interfaces, web-based portals, APIs, and integration points, facilitate interaction with administrators, end-users, devices, and other cloud computing systems. Data components encompass the storage, processing, and transmission of data within the computing environment. This includes databases, file systems, memory, and data pipelines. Contextual attack disruption in the context of data components involves monitoring data flows, access patterns, and data integrity to detect and mitigate attacks targeting sensitive information.

Machine learning engine 640 is a machine learning framework or library that operates as a tool for providing infrastructure, algorithms, capabilities for designing, training, and deploying machine learning models. The machine learning engine 640 can include pre-built functions and APIs that enable building and applying machine learning techniques. The machine learning engine 140 can provide a machine learning workflow from data processing and feature extraction to model training, evaluation, and deployment.

Machine learning data 642 refers to the structured or unstructured information used to train, validate, and test machine learning models. This machine learning data 642 typically comprises input features (also known as independent variables or predictors) and their corresponding target values (also known as dependent variables or labels). Machine learning data 642 can come from various sources, such as databases, sensor readings, text documents, images, audio recordings, or streaming data sources. Machine learning data 642 may require preprocessing, cleaning, and transformation to ensure its suitability for training machine learning models. Additionally, machine learning data 642 is often divided into training, validation, and testing sets to assess the performance and generalization ability of trained models accurately.

Machine learning models 644 are algorithms or mathematical representations that learn patterns and relationships from the provided data to make predictions or decisions without being explicitly programmed. Machine learning models 644 models are trained using the machine learning data 642, where they iteratively adjust their internal parameters or coefficients to minimize prediction errors or maximize performance metrics. Machine learning models 644 can be classified into various types based on their learning algorithms and the nature of the problem they address, including supervised learning models (e.g., regression, classification), unsupervised learning models (e.g., clustering, dimensionality reduction), and reinforcement learning models. Once trained, machine learning models 644 can be deployed in production environments to make predictions on new, unseen data instances. Regular evaluation and monitoring of model performance are essential to ensure their accuracy, reliability, and effectiveness in real-world applications.

The security management client 650 supports access to security management system 660. Security management client 650 provides a graphical or command-line interface for users or administrators to interact with security management system 610, handling tasks such as planning, implementing, controlling, and monitoring security measures to protect assets, resources, and information from various threats and risks in computing environments. The security management client 650 supports centralized security management, security enforcement, and compliance within a computing environment (e.g., organization’s infrastructure), empowering efficient security administration and safeguarding resources.

Secured computing environment 660 can refer to a computing environment that is secured using the security management system 610. For example, cloud computing environments provided by cloud providers encompass various types, including public, private, hybrid, and multi-cloud environments, as well as containerized environments. In a public cloud setup, resources are shared among multiple customers and accessed over the internet, with security managed by the provider through measures like network segmentation and encryption. Private clouds, dedicated to a single organization, offer greater control and are secured through strict access controls and encryption, either by the organization itself or a third-party provider. Hybrid clouds combine elements of public and private clouds, requiring integrated security measures across both environments, such as identity federation and consistent monitoring. Multi-cloud environments leverage services from multiple providers, necessitating standardized security policies and controls for consistent protection. Containerized environments, utilizing technologies like Docker and Kubernetes, secure applications through container image scanning, runtime monitoring, and access control. Across all types, the security management system 610 can provide security management, including compliance certifications, threat intelligence, and security consulting, to safeguard data, infrastructure, and applications from evolving cyber threats and ensure adherence to regulatory requirements.

### EXAMPLE DISTRIBUTED COMPUTING SYSTEM ENVIRONMENT

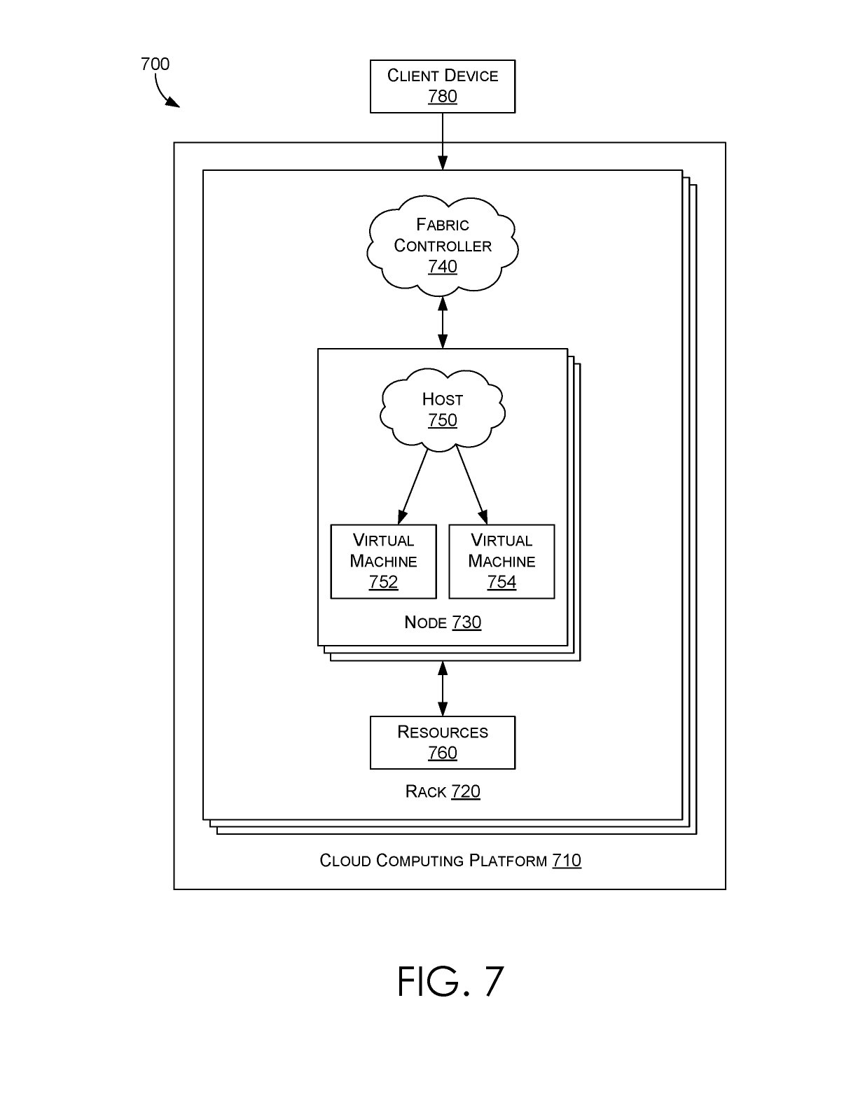

Referring now to FIG. 7, FIG. 7 illustrates an example distributed computing environment 700 in which implementations of the present disclosure may be employed. In particular, FIG. 7 shows a high level architecture of an example cloud computing platform 710 that can host a technical solution environment, or a portion thereof (e.g., a data trustee environment). It should be understood that this and other arrangements described herein are set forth only as examples. For example, as described above, many of the elements described herein may be implemented as discrete or distributed components or in conjunction with other components, and in any suitable combination and location. Other arrangements and elements (e.g., machines, interfaces, functions, orders, and groupings of functions) can be used in addition to or instead of those shown.

Data centers can support distributed computing environment 700 that includes cloud computing platform 710, rack 720, and node 730 (e.g., computing devices, processing units, or blades) in rack 720. The technical solution environment can be implemented with cloud computing platform 710 that runs cloud services across different data centers and geographic regions. Cloud computing platform 710 can implement fabric controller 740 component for provisioning and managing resource allocation, deployment, upgrade, and management of cloud services. Typically, cloud computing platform 710 acts to store data or run service applications in a distributed manner. Cloud computing infrastructure 710 in a data center can be configured to host and support operation of endpoints of a particular service application. Cloud computing infrastructure 710 may be a public cloud, a private cloud, or a dedicated cloud.

Node 730 can be provisioned with host 750 (e.g., operating system or runtime environment) running a defined software stack on node 730. Node 730 can also be configured to perform specialized functionality (e.g., compute nodes or storage nodes) within cloud computing platform 710. Node 730 is allocated to run one or more portions of a service application of a tenant. A tenant can refer to a customer utilizing resources of cloud computing platform 710. Service application components of cloud computing platform 710 that support a particular tenant can be referred to as a multi-tenant infrastructure or tenancy. The terms service application, application, or service are used interchangeably herein and broadly refer to any software, or portions of software, that run on top of, or access storage and compute device locations within, a datacenter.

When more than one separate service application is being supported by nodes 730, nodes 730 may be partitioned into virtual machines (e.g., virtual machine 752 and virtual machine 754). Physical machines can also concurrently run separate service applications. The virtual machines or physical machines can be configured as individualized computing environments that are supported by resources 760 (e.g., hardware resources and software resources) in cloud computing platform 710. It is contemplated that resources can be configured for specific service applications. Further, each service application may be divided into functional portions such that each functional portion is able to run on a separate virtual machine. In cloud computing platform 710, multiple servers may be used to run service applications and perform data storage operations in a cluster. In particular, the servers may perform data operations independently but exposed as a single device referred to as a cluster. Each server in the cluster can be implemented as a node.

Client device 780 may be linked to a service application in cloud computing platform 710. Client device 780 may be any type of computing device, which may correspond to computing device 700 described with reference to FIG. 7, for example, client device 780 can be configured to issue commands to cloud computing platform 710. In embodiments, client device 780 may communicate with service applications through a virtual Internet Protocol (IP) and load balancer or other means that direct communication requests to designated endpoints in cloud computing platform 710. The components of cloud computing platform 710 may communicate with each other over a network (not shown), which may include, without limitation, one or more local area networks (LANs) and/or wide area networks (WANs).

### EXAMPLE COMPUTING ENVIRONMENT

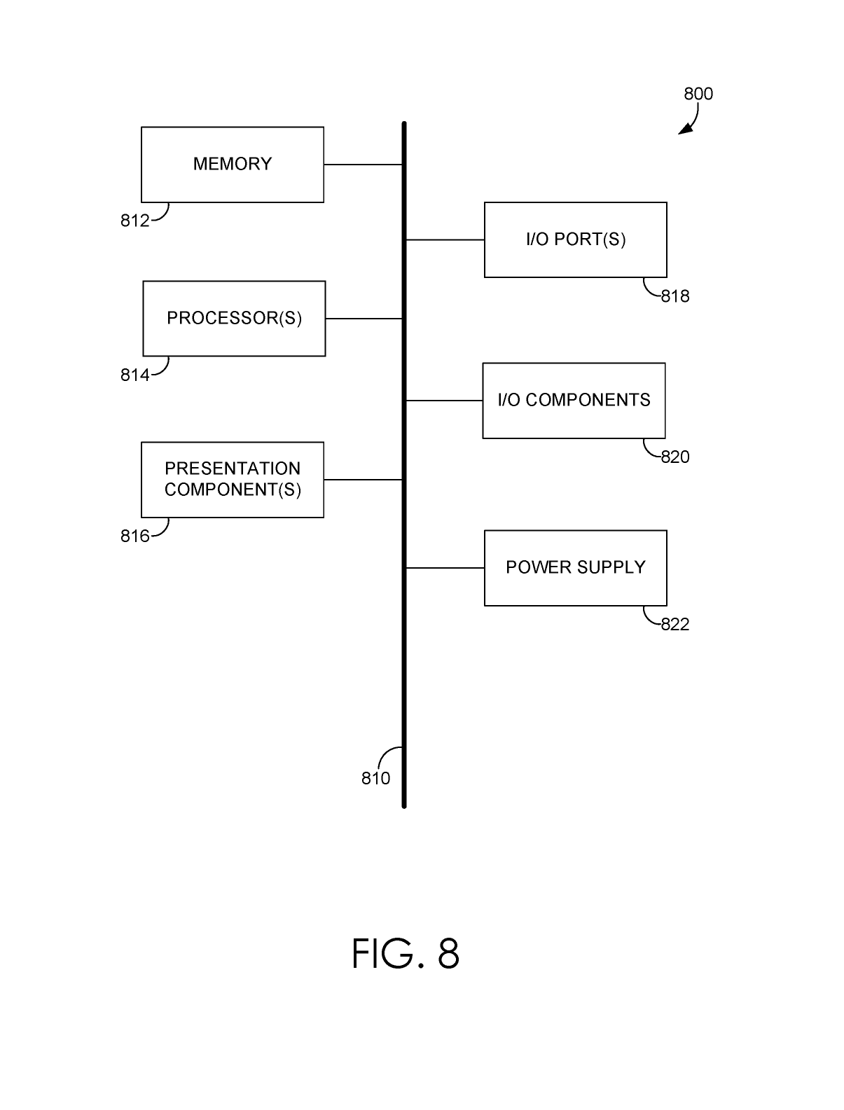

Having briefly described an overview of embodiments of the present technical solution, an example operating environment in which embodiments of the present technical solution may be implemented is described below in order to provide a general context for various aspects of the present technical solution. Referring initially to FIG. 8 in particular, an example operating environment for implementing embodiments of the present technical solution is shown and designated generally as computing device 800. Computing device 800 is but one example of a suitable computing environment and is not intended to suggest any limitation as to the scope of use or functionality of the technical solution. Neither should computing device 800 be interpreted as having any dependency or requirement relating to any one or combination of components illustrated.

The technical solution may be described in the general context of computer code or machine-useable instructions, including computer-executable instructions such as program modules, being executed by a computer or other machine, such as a personal data assistant or other handheld device. Generally, program modules including routines, programs, objects, components, data structures, etc. refer to code that perform particular tasks or implement particular abstract data types. The technical solution may be practiced in a variety of system configurations, including hand-held devices, consumer electronics, general-purpose computers, more specialty computing devices, etc. The technical solution may also be practiced in distributed computing environments where tasks are performed by remote-processing devices that are linked through a communications network.

With reference to FIG. 8, computing device 800 includes bus 810 that directly or indirectly couples the following devices: memory 812, one or more processors 814, one or more presentation components 816, input/output ports 818, input/output components 820, and illustrative power supply 822. Bus 810 represents what may be one or more buses (such as an address bus, data bus, or combination thereof). The various blocks of FIG. 8 are shown with lines for the sake of conceptual clarity, and other arrangements of the described components and/or component functionality are also contemplated. For example, one may consider a presentation component such as a display device to be an I/O component. Also, processors have memory. We recognize that such is the nature of the art, and reiterate that the diagram of FIG. 8 is merely illustrative of an example computing device that can be used in connection with one or more embodiments of the present technical solution. Distinction is not made between such categories as “workstation,” “server,” “laptop,” “hand-held device,” etc., as all are contemplated within the scope of FIG. 8 and reference to “computing device.”

Computing device 800 typically includes a variety of computer-readable media. Computer-readable media can be any available media that can be accessed by computing device 800 and includes both volatile and nonvolatile media, removable and non-removable media. By way of example, and not limitation, computer-readable media may comprise computer storage media and communication media.

Computer storage media include volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 800. Computer storage media excludes signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 812 includes computer storage media in the form of volatile and/or nonvolatile memory. The memory may be removable, non-removable, or a combination thereof. Exemplary hardware devices include solid-state memory, hard drives, optical-disc drives, etc. Computing device 800 includes one or more processors that read data from various entities such as memory 812 or I/O components 820. Presentation component(s) 816 present data indications to a user or other device. Exemplary presentation components include a display device, speaker, printing component, vibrating component, etc.

I/O ports 818 allow computing device 800 to be logically coupled to other devices including I/O components 820, some of which may be built in. Illustrative components include a microphone, joystick, game pad, satellite dish, scanner, printer, wireless device, etc.

### ADDITIONAL STRUCTURAL AND FUNCTIONAL FEATURES OF EMBODIMENTS OF THE TECHNICAL SOLUTION

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software, as described below. For instance, various functions may be carried out by a processor executing instructions stored in memory. As such, other arrangements and elements (e.g., machines, interfaces, functions, orders, and groupings of functions) can be used in addition to or instead of those shown.

Embodiments described in the paragraphs below may be combined with one or more of the specifically described alternatives. In particular, an embodiment that is claimed may contain a reference, in the alternative, to more than one other embodiment. The embodiment that is claimed may specify a further limitation of the subject matter claimed.

The subject matter of embodiments of the technical solution is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

For purposes of this disclosure, the word “including” has the same broad meaning as the word “comprising,” and the word “accessing” comprises “receiving,” “referencing,” or “retrieving.” Further the word “communicating” has the same broad meaning as the word “receiving,” or “transmitting” facilitated by software or hardware-based buses, receivers, or transmitters using communication media described herein. In addition, words such as “a” and “an,” unless otherwise indicated to the contrary, include the plural as well as the singular. Thus, for example, the constraint of “a feature” is satisfied where one or more features are present. Also, the term “or” includes the conjunctive, the disjunctive, and both (a or b thus includes either a or b, as well as a and b).

For purposes of a detailed discussion above, embodiments of the present technical solution are described with reference to a distributed computing environment; however the distributed computing environment depicted herein is merely exemplary. Components can be configured for performing novel aspects of embodiments, where the term “configured for” can refer to “programmed to” perform particular tasks or implement particular abstract data types using code. Further, while embodiments of the present technical solution may generally refer to the technical solution environment and the schematics described herein, it is understood that the techniques described may be extended to other implementation contexts.

For purposes of this disclosure the word “support” refers to provisioning of functionality, services, or assistance by a computing component or through computing operations within a broader computing system. When a computing component or set of operations supports a specific functionality, it means that it plays a role in enabling or executing that particular aspect of the computing system. This support can manifest in various ways, including the processing of data, execution of operations, management of resources, and ensuring compatibility or interoperability with other components. Additionally, support may involve providing interfaces, APIs (Application Programming Interfaces), or protocols that allow seamless interaction and integration with other elements of the computing system. The concept of support extends beyond mere functionality provision to encompass maintenance, troubleshooting, and the overall optimization of computing resources to ensure the robust and efficient operation of the computing system.

Embodiments of the present technical solution have been described in relation to particular embodiments which are intended in all respects to be illustrative rather than restrictive. Alternative embodiments will become apparent to those of ordinary skill in the art to which the present technical solution pertains without departing from its scope.

From the foregoing, it will be seen that this technical solution is one well adapted to attain all the ends and objects hereinabove set forth together with other advantages which are obvious and which are inherent to the structure.

It will be understood that certain features and sub-combinations are of utility and may be employed without reference to other features or sub-combinations. This is contemplated by and is within the scope of the claims.

1. A computerized system comprising:
one or more computer processors; and computer memory storing computer-useable instructions that, when used by the one or more computer processors, cause the one or more computer processors to perform operations, the operations comprising:
accessing a graph, the graph representing relationships between entities of a computing environment and storing security information about the computing environment;
generating a matrix from the graph, wherein an entry of the matrix indicates a connection, or lack of connection, between two nodes of the graph;
generating an adjacency matrix from the graph. wherein the adjacency matrix comprises a plurality of matrix entries that describe nodes in the security graph and at least one authorized operation of a first node with respect to a second node
using the connectivity score, generating an insight related to the security of the computing environment; and
communicating the insight to a security management client.

2. The system of claim 1, wherein the insight is an identification of an attack path in the computing environment.

3. The system of claim 1, wherein analyzing the matrix comprises executing matrix operations, the matrix operations comprising any of: matrix exponentiation, sparse matrix optimization, and block matrix multiplication.

4. The system of claim 1, where analyzing the matrix comprises executing a block matrix multiplication on the graph organized as blocks.

5. The system of claim 1, wherein analyzing the matrix comprises executing matrix exponentiation that raises the matrix to the power k to discover a number paths of the length k between nodes.

6. The system of claim 1, wherein analyzing the matrix comprises any of: path discovery, connectivity analysis, clustering coefficient calculation, and modularity calculation.

7. The system of claim 1, the operations further comprising generating an actionable recommendation based on the insight and a Key Performance Indicator (KPI) associated with a threshold.

8. The system of claim 1, the operations further comprising detecting anomalies in the computing environment by performing real-time monitoring of the computing environment by way of the graph and the matrix, wherein real-time monitoring triggers generating alerts in response to detecting anomalies.

9. The system of claim 1, the operations further comprising:communicating, from the security management client, a request for security information about the computing environment;
in response to communicating the request, receiving a visualization of security information comprising one or more insights computed from the graph and the matrix; and
causing display of the visualization on the security management client.

10. The system of claim 1, the operations further comprising: receiving an indication to execute a remediation action associated with the insight; and
communicating the indication to execute the remediation action to cause execution of the remediation action.

11. A computer-implemented method, the method comprising:
identifying a security incident associated with a computing environment; accessing a graph representing security information about the computing environment;
generating an adjacency matrix from the graph, wherein an entry of the adjacency matrix indicates an access permission level associated with a direct edge between two nodes in the graph;
generating a connectivity score by analyzing the matrix, wherein the connectivity score is a metric used to evaluate connectivity within the graph;
using the connectivity score, detecting an anomaly in the computing environment using real-time monitoring of the computing environment by way of the graph and the matrix; and
in response to detecting the anomaly, generating an alert.

12. The method of claim 11, wherein analyzing the matrix comprises executing matrix operations, the matrix operations comprising any of: matrix exponentiation, sparse matrix optimization, and block matrix multiplication.

13. The method of claim 11, wherein analyzing the matrix comprises executing a block matrix multiplication on the security graph organized as blocks.

14. The method of claim 11, wherein analyzing the matrix comprises executing matrix exponentiation that raises the matrix to the power k to discover a number paths of the length k between nodes.

15. The method of claim 11, wherein analyzing the matrix comprises any of: path discovery, connectivity analysis, clustering coefficient calculation, and modularity calculation.

16. The method of claim 11, the method further comprising:generating a visualization comprising one or more insights computed from the graph and the matrix, wherein an insight is an identification of an attack path in the computing environment.

17. One or more non-transitory computer-storage media having computer-executable instructions embodied thereon that, when executed by a computing system having a processor and memory, cause the processor to perform operations, the operations comprising:
communicating a request for security information about a computing environment;based on communicating the request, receiving a visualization comprising one or more insights based on a graph and an adjacency matrix, wherein the adjacency matrix includes weighted matrix entries that encode a permission type for a connection between nodes; andcausing display of the visualization on a security management client.

18. The media of claim 17, the operations further comprising: identifying a security incident associated with the computing environment; accessing the graph representing security information about the computing environment;
generating the matrix from the graph;
generating a connectivity score by analyzing the matrix, wherein the connectivity score is a metric used to evaluate connectivity within the graph;
using the connectivity score, detecting an anomaly in the computing environment using real-time monitoring of the computing environment by way of the graph and the matrix; and
in response to detecting the anomaly, generating an alert.

19. The media of claim 17, wherein the matrix is associated with executing matrix operations, the matrix operations including matrix exponentiation, sparse matrix optimization, and block matrix multiplication.

20. The media of claim 17, wherein analyzing the matrix comprises any of: path discovery, connectivity analysis, clustering coefficient calculation, and modularity calculation.
